(19) United States
(12) Patent Application Publication
(10) Pub. No.: US 2017/0255996 A1
(43) Pub. Date: Sep. 7, 2017

(54) HETEROGENEOUS RESOURCE ALLOCATION FOR AUTOMATIC RISK TARGETING AND ACTION PRIORITIZATION IN LOAN MONITORING APPLICATIONS

(71) Applicant: Xerox Corporation, Norwalk, CT (US)

(72) Inventors: Alvaro E. Gil, Rochester, NY (US); Edgar A. Bernal, Webster, NY (US); Shanmuga-Nathan Gnanasambandam, Victor, NY (US)

(21) Appl. No.: 15/062,815

(22) Filed: Mar. 7, 2016

(51) Int. Cl. G06Q 40/02

(52) U.S. Cl. CPC G06Q 40/025

(57) ABSTRACT

A system, method, and apparatus for determining risk associated with a plurality of loan accounts, having an off-line mode and an online mode. In the off-line mode a first plurality of account histories is received. A maximum value variable m is set. A definition is received of a predetermined maximum look-ahead timeframe p. An iterative variable i is set equal to zero. While i is less than the maximum value variable m, a plurality of variables associated with an account history equaling the iterative variable i are stored and i incremented by 1. A predictive multi-output risk model is trained. In the online mode, a second plurality of account histories is received. A determination is made which accounts have a future risk level greater than a current risk level, and a further determination made which accounts currently require one or more tasks. Accounts requiring tasks are automatically assigned.

### TECHNICAL FIELD

The present invention is generally related to a determination of future loan risk associated with a plurality of loan accounts. More specifically, the invention is directed towards a system, method, and apparatus utilizing a specialized computing device to first receive in an off-line mode a plurality of loan account histories describing loan accounts for loan risk analysis and utilizing the plurality of loan account histories to train a predictive multi-output risk model. An online mode follows when the trained predictive multi-output risk model is used to determine which one or more loan accounts of the plurality of loan accounts have a future risk level greater than a current risk level, followed by automatically determining by the specialized computing device which loan accounts of those with increasing risk level require one or more tasks associated with loan servicing. The one or more loan accounts determined to have future risk level greater than current risk level and requiring tasks associated with loan servicing are then prioritized for assignment and automatically assigned by the computing device for loan servicing.

This application is related to U.S. patent application Ser. No. 14/222,099, “Method, System, and Apparatus for Semi-Automatic and Automatic Targeting and Action Prioritization in Loan Monitoring Applications,” filed on Mar. 21, 2014 and presently published as United States Patent Application Publication 2015/0269670. This application is incorporated by reference in its entirety here.

### BACKGROUND

The personal lending industry, including the lending of student loans, auto loans, commercial loans, and mortgages, as well as other types of personal loans is valued at trillions of dollars in the United States in the twenty-first century. The total value of mortgages outstanding alone in the United States is approximately $10trillion dollars. It could thus be roughly estimated that in the example of a lender, guarantor, servicer, or other organizations managing a portfolio of student loans (for example), more than 14% of customers might be expected to be in default at any time. Generally, lenders/guarantors/servicers/other organizations involved in reducing financial risk within any type of account portfolio (whether mortgages, auto loans, commercial loans, personal lines of credit, credit cards, or any other) experience some level of financial risk, and desire to reduce it. Accordingly, a need exists for a system, method, and apparatus determining and reducing future loan risk associated with a plurality of loan accounts.

### SUMMARY

A first embodiment of the present invention is directed to a system, method, and apparatus for determining a future risk associated with a plurality of accounts. In the first embodiment of the invention, there is an off-line mode and an online mode, both associated with the specialized computing device. During the off-line mode, the specialized computing device receives and stores into associated memory a first plurality of account histories describing the plurality of accounts for risk analysis, the first plurality of account histories stored in and transmitted from a first computer database. The maximum value variable m is set equal to a number of the received first plurality of account histories. A definition is received from a single user of a predetermined maximum look-ahead timeframe p. The iterative variable i is initialized and set equal to zero. While the iterative variable i is less than the maximum value variable m then iteratively performing the steps of first retrieving and storing into memory associated with the specialized computing device a plurality of variables associated with an account history of the first plurality of account histories equaling the iterative variable i of the plurality of account histories, and then incrementing the iterative variable by one. As one of skill in the art knows, such a process causes an iterative loop to process all of the available data until there is none left to process (i.e. when the iterative variable equals or is greater than the maximum value variable m). The specialized computing device then trains a predictive multi-output risk model using all of the pluralities of variables associated with all of the account histories stored previously in memory, the predictive multi-output risk model describing a current risk level and a future risk level according to a periodic basis up to the predetermined maximum look-ahead timeframe p. The periodic basis may be one day, one week, one month, six months, and one year.

During the online mode, following the off-line mode of the first embodiment, the specialized computing device receives and stores into associated memory a second plurality of account histories, the second plurality of account histories stored in and transmitted from a second computer database. The second plurality of account histories stored in the second computer database may be an updating of the first plurality of account histories contained in the first computer database, a plurality of account histories not contained in the first computer database, and a combination of the updating of the first plurality of account histories and the plurality of account histories not contained in the first computer database. As the online mode proceeds, the specialized computing device then determines, based upon the trained predictive multi-output risk model, which one or more accounts with histories stored in the second computer database have a future risk level greater than a current risk level. A third computer database associated with the specialized computing device is accessed, the third computer database storing data regarding servicing histories of the one or more accounts contained in the second database and determined to have future risk level greater than current risk level by the specialized computing device based upon the trained predictive multi-output risk model. The data regarding servicing histories may include at least a date of origination, a date of first servicing, zero or more dates of subsequent servicing, and zero or more dates of payments made.

The specialized computing device continues by determining which accounts of the one or more determined to have future risk level greater than current risk level currently require one or more tasks associated with servicing, based upon the data regarding servicing histories previously accessed. The one or more tasks associated with servicing may be one or more of the following: requesting a payment on the determined one or more accounts, advising of delinquency regarding the determined one or more accounts, advising of a pay-off amount for the determined one or more accounts, and responding to a specific client request regarding the determined one or more accounts. The specialized computing device prioritizes for assignment one or more accounts determined to have future risk level greater than current risk level and requiring one or more tasks associated with servicing. The prioritizing for assignment the one or more accounts determined to have future risk level greater than current risk level may involve the use of control strategies and a Universal Stabilizing Mechanism to guarantee all accounts are serviced. Alternately, the prioritizing for assignment the one or more accounts determined to have future risk level greater than current risk level may comprise automatically determining one or more accounts whose prioritized time since previous servicing satisfies a prioritization criterion or with a longest time since previous servicing, based upon the data regarding servicing histories in the third computer database. During enforcement of the online prioritization criterion, as previously described, the automatic determination of the one or more prioritized accounts comprises of selecting accounts with prioritized time greater or equal to the average prioritized time of all or a group of accounts since previous servicing at time tₖj, such that:

$${T}_{{k}_{j}^{*}} ( {t}_{{k}_{j}^{*}} ) \geq \frac{1}{n - m} {Σ}_{{k}_{j} ∈ U ( {t}_{{k}_{j}} )} {T}_{{k}_{j}} ( {t}_{{k}_{j}} ) .$$

Alternately, during enforcement of the online prioritization criterion, the automatic determination of the one or more prioritized accounts comprises of selecting accounts with a longest prioritized time since previous servicing at time tₖj, such that:

T_{k*}_{ⱼ}(t_{k*}_{ⱼ})=maxₖ_{ⱼ}_{∈U(t}_{ₖⱼ}₎{Tₖ_{ⱼ}(tₖ_{ⱼ})}

The specialized computing device finally assigns automatically the prioritized one or more accounts requiring servicing. In a further embodiment, before automatically assigning the prioritized one or more accounts a complexity of the one or more tasks associated with servicing is determined. The complexity level of the one or more tasks may be related to a history of prior engagements with a customer associated with each account the task is required for. An allocation strategy, such as

$${T}_{{k}_{j}^{*}} ( {t}_{{k}_{j}^{*}} ) \geq \frac{1}{n - m} {Σ}_{{k}_{j} ∈ U ( {t}_{{k}_{j}} )} {T}_{{k}_{j}} ( {t}_{{k}_{j}} ) ,$$

may be used to assign one or more accounts to one or more agents. Alternately, a heuristic allocation strategy may be used to assign one or more accounts to one or more agents.

A second embodiment of the present invention is directed to a system, method, and apparatus for allocation of a plurality of loan accounts to a plurality of agents by a specialized computing device managing a contact center. In the second embodiment of the invention, there may be an off-line mode and an online mode, both associated with the specialized computing device. During the off-line mode, the specialized computing device receives and stores into associated memory a first plurality of loan account histories describing the plurality of loan accounts for loan risk analysis and a description of the plurality of agents, the first plurality of loan account histories stored in and transmitted from a first computer database. The specialized computing device stores in associated memory a plurality of variables describing the plurality of loan account histories. A definition is received from a single user of a predetermined maximum look-ahead timeframe p. The specialized computing device trains a predictive multi-output risk model using all of the pluralities of variables associated with all of the loan account histories stored previously in memory, the predictive multi-output risk model describing a current risk level and a future risk level according to a periodic basis up to the predetermined maximum look-ahead timeframe p. The periodic basis may be equal to one day, one week, one month, six months, and one year.

During the online mode, following the off-line mode of the second embodiment, the specialized computing device receives and stores into associated memory a second plurality of account histories, the second plurality of loan account histories stored in and transmitted from a second computer database. The second plurality of loan account histories may be an updating of the first plurality of loan account histories contained in the first computer database, a plurality of loan account histories not contained in the first computer database, and a combination of the updating of the first plurality of loan account histories and the plurality of loan account histories not contained in the first computer database. The specialized computing device then determines, based upon the trained predictive multi-output risk model, which one or more loan accounts with histories stored in the second computer database have a future risk level greater than a current risk level. A third computer database associated with the specialized computing device is accessed, the third computer database storing data regarding loan servicing histories of the one or more loan accounts contained in the second database and determined to have future risk level greater than current risk level by the specialized computing device based upon the trained predictive multi-output risk model. The data regarding loan servicing histories of the one or more loan accounts stored in the third database may include a date of loan origination, a date of first loan servicing, zero or more dates of subsequent loan servicing, and zero or more dates of loan payments made. A determination is then made which loan accounts of those identified to have future risk level greater than current risk level currently require one or more tasks associated with loan servicing based upon the data regarding loan servicing histories previously accessed.

The specialized computing device then prioritizes for assignment one or more loan accounts determined to have future risk level greater than current risk level and requiring one or more tasks associated with loan servicing. The prioritizing for assignment the one or more loan accounts may entail automatically determining one or more loan accounts whose prioritized time since previous loan servicing satisfies a prioritization criterion, based upon the data regarding loan servicing histories in the third computer database. The tasks associated with loan servicing may be requesting a payment on the determined one or more loan accounts, advising of delinquency regarding the determined one or more loan accounts, advising of a pay-off amount for the determined one or more loan accounts, and responding to a specific client request regarding the determined one or more loan accounts.

Enforcement of the prioritization criterion, as previously described, comprises of selecting accounts with prioritized time greater or equal to the average prioritized time of all or a group of accounts since previous servicing at time tₖj, such that accounts indexed by kⱼ* satisfy:

$${T}_{{k}_{j}^{*}} ( {t}_{{k}_{j}^{*}} ) \geq \frac{1}{n - m} {Σ}_{{k}_{j} ∈ U ( {t}_{{k}_{j}} )} {T}_{{k}_{j}} ( {t}_{{k}_{j}} ) .$$

Alternately, enforcement of the prioritization criterion comprises selecting accounts with longest prioritized time since previous servicing at time tₖj, such that accounts indexed by kⱼ* satisfy:

T_{k*}_{ⱼ}(t_{k*}_{ⱼ})=maxₖ_{ⱼ}_{∈U(t}_{ₖⱼ}₎{Tₖ_{ⱼ}(tₖ_{ⱼ})}.

When prioritizing by the specialized computing device for assignment the one or more loan accounts determined to have future risk level greater than current risk level control strategies are used to generate an allocation of accounts and a Universal Stabilizing Mechanism guarantees all accounts are serviced. The Universal Stabilizing Mechanism may have input into it as well complexity levels of tasks associated with the accounts. The control strategies may include an allocation strategy where accounts indexed by kⱼ* such that

$${T}_{{k}_{j}^{*}} ( {t}_{{k}_{j}^{*}} ) \geq \frac{1}{n - m} {Σ}_{{k}_{j} ∈ U ( {t}_{{k}_{j}} )} {T}_{{k}_{j}} ( {t}_{{k}_{j}} )$$

are assigned to one or more available agents. Alternately, the control strategy may be a heuristic allocation strategy may be used to assign one or more accounts to one or more agents.

The specialized computing device finally assigns automatically the prioritized one or more loan accounts requiring loan servicing. Before automatic assignment, a complexity of the one or more tasks associated with loan servicing may be determined. The complexity level of the one or more tasks may be derived from data of prior and current engagements with a customer associated with each loan account the task is required for. The complexity level may also be derived from the number of times that an agent did not finish processing an account, profiles of agents and accounts, processing times, and descriptive statistics of probabilistic processing times. The automatic determination of the one or more prioritized loan accounts may further comprise selecting a subset of the set of initially selected accounts based on the estimated complexity level of tasks associated with accounts in the set.

An allocation strategy, such as

$${T}_{{k}_{j}^{*}} ( {t}_{{k}_{j}^{*}} ) \geq \frac{1}{n - m} {Σ}_{{k}_{j} ∈ U ( {t}_{{k}_{j}} )} {T}_{{k}_{j}} ( {t}_{{k}_{j}} ) ,$$

may be used to assign one or more accounts to one or more agents. Alternately, a heuristic allocation strategy may be used to assign one or more accounts to one or more agents.

These and other aspects, objectives, features, and advantages of the disclosed technologies will become apparent from the following detailed description of illustrative embodiments thereof, which is to be read in connection with the accompanying drawings.

### BRIEF DESCRIPTION OF THE DRAWINGS

FIGS. 1A and 1B are a flowchart displaying a process of execution of a first embodiment of the invention.

FIGS. 2A and 2B are a block diagram showing a process of execution of an embodiment of the invention.

FIG. 3 is a chart displaying results of a processing of assignment of loan accounts, in an embodiment of the invention.

FIG. 4 is a flowchart displaying a process of execution of an embodiment of the invention.

FIGS. 5A and 5B are a flowchart displaying a process of execution of a second embodiment of the invention.

### DETAILED DESCRIPTION

Describing now in further detail these exemplary embodiments with reference to the figures as described above, the systems, methods, and apparatuses for Heterogeneous Resource Allocation for Automatic Risk Targeting and Action Prioritization in Loan Monitoring Applications is described below. It should be noted that drawings as displayed are not to scale.

As used herein, certain variables are defined as follows. Loan accounts may be designated k. Variable t=0, 1, 2, . . . denotes a time index. Variable [symbol] ₖ, k ∈ P={1, . . . , n} denotes the priority (importance) of loan account k. Tₖ(t), k ∈ P, t≧0 denotes the “prioritized time” since last processing of bank account k, and tₖ denote the time since the last processing of bank account k (e.g., if bank account k was last processed at time zero then the quantity Tₖ(t)= [symbol] ₖ* tₖ, is its “prioritized time”). Denote the set of agents as Q={1, 2, . . . , m} where n>m (there are more accounts than agents), assuming that the number of agents is constant, for the purposes of the presently disclosed invention. The set U(t) ⊂ P is defined as the set of “unattended” bank accounts either not processed or being pursued by any agent at the current time t. For the purposes of this application, k*ⱼ(t) designates the task being processed by agent j ∈ Q at time t. A(t) is defined as the set of bank accounts processed by the group of m agents at the current time t; hence P=U(t) ∪ A(t), t≧0. Let τₖ, 0<τ≦τₖ≦τ̅, k ∈ P, denote the time any agent takes to process bank account k with τ(τ̅) being the minimum (maximum) processing time. Here assignment for processing may include sending an email, calling, mailing a letter to the account holder, or any other action aimed at addressing a risky account. ζ designates a maximum time unit for processing of loan account. [symbol] designates a first-in first-out queue.

An “account,” or “loan account” within the context of this and associated patent applications is a record of debt (typically, debt issued for or resulting from a specific purpose such as a payment for school tuition, mortgaging or refinancing a house, purchasing an automobile, payments for medical/dental services rendered, payments for utility services, paying off a credit card, payments for goods and/or services from a merchant, upcoming medical screening or vaccination scheduling, etc.), although any necessary repayment of debt qualifies. Accounts may have zero or more “financial transactions” associated with them, financial transactions including but not limited to issuance of the associated debt, payments made and applied, credits applied, late charges issued, monthly interest compounded, etc. The “action history” or “loan account history” associated with an account is a history of financial transactions, including initial account amounts, payments made, dates associated with payments, payments missed, late charges charged, late charges paid, late charges waived, etc. An account contains one or more of the following (depending on the nature and particulars of the account): principal amount, interest rate, terms of repayment, date(s) of repayment made, dates of required payments, dates of missed payments, amount of required payments, date of service rendered, etc. As discussed within, this patent application and associated patent applications, an account and an associated loan account history exist in a format accessible to a specialized computing device for processing as a spreadsheet, .csv value, matrix (as defined by programming languages utilizing matrices or as may be understood by one of skill in the art to utilize matrices), an array, a database entry, a linked-list, a tree-structure, other types of computer files or variables (or any other presently existing or after-arising equivalent). Variables tracked include (if appropriate), but are not limited to, the origination/initiation date of the account, dates goods/services were provided or other disbursements, the original amount of the account balance, the remaining principle balance to be paid, the dates of the payments made, dates of payments due, the current interest rate, the terms of repayment, total number of original monthly payments, number of remaining monthly payments, whether each monthly payment was timely (true/false), number days delinquent of every monthly payment (from 0-integer), credit score of account holder at various points in time, original goods/services provided, etc. In a further embodiment of the invention, variables further include account status (ls) (current or not), delinquency days (dd), and forbearance months (fin).

A “specialized computing device,” as discussed in the context of this patent application and related patent applications, refers to one or multiple computer processors acting together, a logic device or devices, an embedded system or systems, or any other device or devices allowing for programming and decision making The specialized computing device discussed herein may manage a “contact center,” as further discussed below. Multiple computer systems with associated specialized computing devices may also be networked together in a local-area network or via the internet to perform the same function, and are therefore also a “specialized computing device” for the reasons discussed herein. In one embodiment, a specialized computing device may be multiple processors or circuitry performing discrete tasks in communication with each other. The system, method, and apparatus described herein are implemented in various embodiments as, to execute on a “specialized computing device[s],” or, as is commonly known in the art, such a device specially programmed in order to perform a task at hand. A specialized computing device is a necessary element to process the large amount of data (i.e., thousands, tens of thousands, hundreds of thousands, or more of accounts and account histories). Furthermore, the present invention may take the form of a computer program product embodied in any tangible medium of expression having computer usable program code embodied in the medium. Computer program code for carrying out operations of the present invention may operate on any or all of the “specialized computing device,” “server,” “computing device,” “computer device,” or “system” discussed herein. Computer program code for carrying out operations of the present invention may be written in any combination of one or more programming languages, including an object-oriented programming language such as Java, Smalltalk, C++, or the like, conventional procedural programming languages, such as Visual Basic, “C,” or similar programming languages. After-arising programming languages are contemplated as well.

A “contact center,” as discussed in the context of this patent application and related patent applications, refers to a facility, group of facilities, or other physical arrangement to manage customer contact using any and/or all of the communication channels as further discussed herein for a business, company, charity, or any other organization of individuals. A “call center” is an example of a type of contact center which focuses on utilization of telephones to contact customers.

As used herein, a “communication channel” is defined as any manner of contacting a customer from a contact center or elsewhere. Examples of communication channels include telephone calls, e-mails, web-chats, instant messages, messages transmitted via social media (e.g., Facebook®), text messages, facsimiles, letters, or any other presently existing or after-arising equivalent or equivalents allowing contact with a customer. A “communication” is of the type standard, as one of skill in the art knows, as utilized along with the above-discussed communication channels.

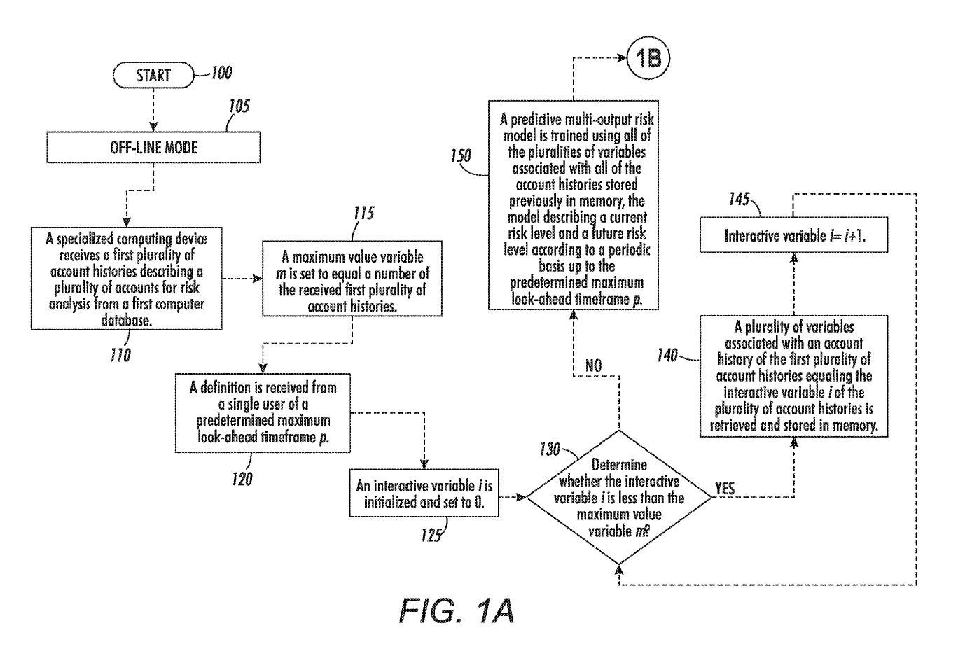

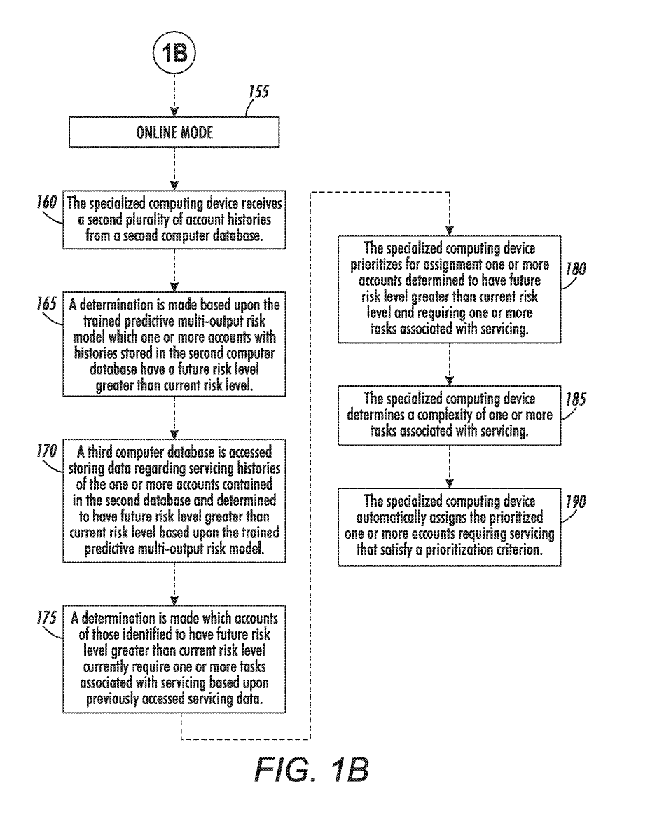

Referring to FIG. 1A, displayed is a flowchart displaying a process of execution of a first embodiment of the invention. Execution begins at step 100. An “Off-Line Mode” begins, in an embodiment of the invention, at step 105 and onwards. At step 110 a specialized computing device receives a first plurality of account histories describing a plurality of accounts for risk analysis from a first computer database. As to be understood in the context of the presently disclosed invention, any and all databases discussed herein may be one database or multiple databases linked together, all serving requests for data as may be transacted by the specialized computing device or any other computing device discussed herein.

At step 115 a maximum value variable m is set to equal a number of the received first plurality of account histories. At step 120 a definition is received from a single user of a predetermined maximum look-ahead timeframe p. At step 125 an iterative variable i is initialized and set to 0. A determination is then made whether the iterative variable i is less than the maximum value variable m at step 130. If yes, then at step 140 a plurality of variables associated with an account history of the first plurality of account histories equaling the iterative variable i of the plurality of account histories is retrieved and stored into memory, then at step 145 the iterative variable i is incremented by 1 (or, as one of skill in the art understands, iterative variable i=i+1). If execution did proceed through steps 140 and 145, execution returns to step 130 and another determination is made whether the iterative variable i is less than the maximum value variable m. Eventually, execution proceeds to step 150 where a predictive multi-output risk model is trained using all of the pluralities of variables associated with all of the account histories stored previously in memory, the model describing a current risk level and a future risk level according to a periodic basis up to the predetermined maximum look-ahead timeframe p. The periodic basis used in training the predictive multi-output risk model may equal, in various embodiments, to one day, one week, one month, six months, and one year. Execution then proceeds to FIG. 1B, as is further discussed below. Execution of the off-line mode is complete with the training of the risk model and storing of its parameters.

Referring to FIG. 1B, displayed is a flowchart displaying a further process of execution of an embodiment of the invention. As discussed in step 155 and onwards, in an embodiment of the invention an “Online Mode” 155 et seq. follows the “Off-Line mode” 105 et seq. At step 160 the specialized computing device receives a second plurality of account histories from a second computer database. The second plurality of account histories stored in the second computer database may comprise one or more of the following: an updating of the first plurality of account histories contained in the first computer database, a plurality of account histories not contained in the first computer database, and a combination of the updating of the first plurality of account histories and the plurality of account histories not contained in the first computer database. At step 165 a determination is made based upon the trained predictive multi-output risk model which one or more accounts with histories stored in the second computer database have a future risk level greater than a current risk level. At step 170 a third computer database is accessed storing data regarding servicing histories of the one or more accounts contained in the second database and determined to have future risk level greater than current risk level based upon the trained predictive multi-output risk model. The data regarding servicing histories of the one or more accounts stored in the third database includes at least a date of origination, a date of first servicing, zero or more dates of subsequent servicing, and zero or more dates of payments made. At step 175 a determination is made which accounts of those identified to have future risk level greater than current risk level currently require one or more tasks associated with servicing based upon previously accessed servicing data. Tasks associated with servicing may be one or more of the following, including requesting a payment on the determined one or more accounts, advising of delinquency regarding the determined one or more accounts, advising of a pay-off amount for the determined one or more accounts, and responding to a specific client request regarding the determined one or more accounts. At step 180 the specialized computing device prioritizes for assignment one or more accounts determined to have future risk level greater than current risk level and requiring one or more tasks associated with servicing. In a further embodiment of the invention, when the specialized computing device prioritizes for assignment one or more accounts determined to have future risk level greater than current risk level this step comprises automatically determining an account with a longest prioritized time since previous servicing, based upon the data regarding servicing histories in the third computer database. At step 185, the specialized computing device determines a complexity of the one or more tasks associated with servicing. In an embodiment of the invention, the complexity level of the one or more tasks is related to a history of prior engagements with a customer associated with each account the task is required for. At step 190 the specialized computing device automatically assigns the prioritized one or more accounts requiring servicing that satisfy the prioritization criterion. In an embodiment of the invention, the automatic assignment of the one or more prioritized accounts consists in a prioritization criterion that selects accounts with prioritized time greater or equal to the average prioritized time of all or a group of accounts since previous loan servicing at time tₖj, such that:

$${T}_{{k}_{j}^{*}} ( {t}_{{k}_{j}^{*}} ) \geq \frac{1}{n - m} {Σ}_{{k}_{j} ∈ U ( {t}_{{k}_{j}} )} {T}_{{k}_{j}} ( {t}_{{k}_{j}} ) \qquad Equation 1$$

In another embodiment, the automatic assignment of the one or more prioritized loan accounts consists in a prioritization criterion that selects accounts with longest prioritized time since previous loan servicing at time tₖj, such that:

T_{k*}_{ⱼ}(t_{k*}_{ⱼ})=maxₖ_{ⱼ}_{∈U(t}_{ₖⱼ}₎{Tₖ_{ⱼ}(tₖ_{ⱼ})} Equation 2

If either method of controlling automatic assignment is used, in an embodiment of the invention a mutual exclusion algorithm may be utilized as well which coordinates the access to the set U (tₖ_{ⱼ}) in such a way that the set U (tₖ_{ⱼ}) may be accessed and updated only once at a time. Alternately, a simpler option is to simply pre-establish the order in which decisions are made. In various embodiments two or more accounts are assigned to an agent if he/she/it has the capability to do so. Equation 1 above discusses how decisions are made over a range of m times, not just one at a time.

Automatic assignment for servicing, as discussed above in connection with step 190, may include automatic servicing such as sending an e-mail, placing a telephone call, mailing a letter to an account holder, or any other action. Any of these tasks may be completed by the specialized computing device using automated methodology as one of skill in the art knows. Alternately, the presently disclosed invention may automatically assign via the specialized computing device an account for servicing by an agent using the presently disclosed invention. A contact center may offer a communication channel for an agent to initiate a contact for servicing. The specialized computing device may maintain information regarding relative skill levels of various agents.

In a further embodiment of the invention, after step 190 as discussed above, automatic assignment of the one or more prioritized accounts requiring servicing, the specialized computing device may perform more steps including: (1) Accessing the third computer database to determine which accounts currently require one or more tasks associated with servicing; (2) Determine of these accounts, which has a next longest prioritized time since servicing; (3) Determine a next available agent for servicing; (4) Automatically assigning accounts still requiring servicing; and (5) Continuing to perform steps (1)-(4) as a computerized loop.

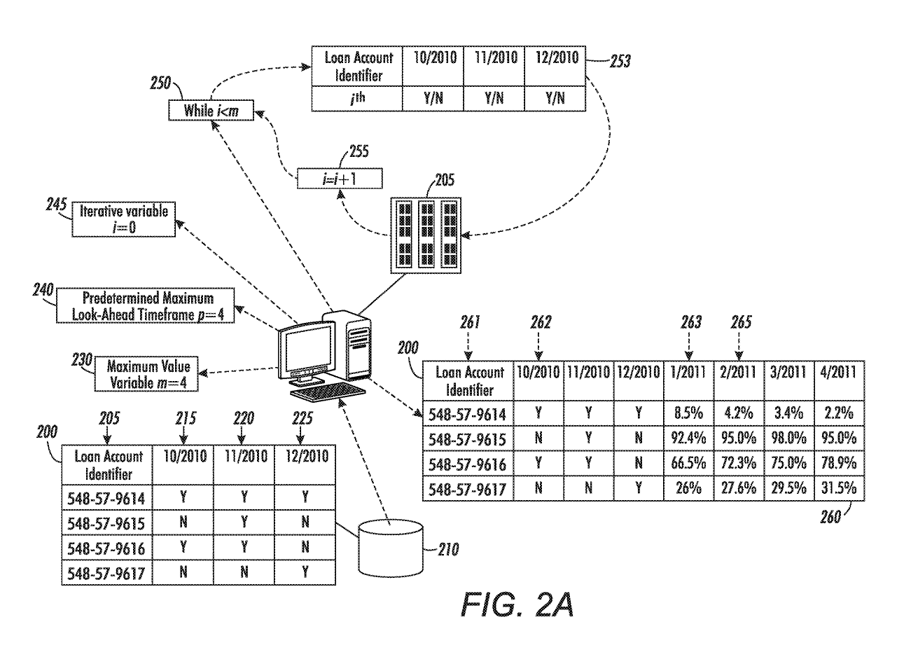

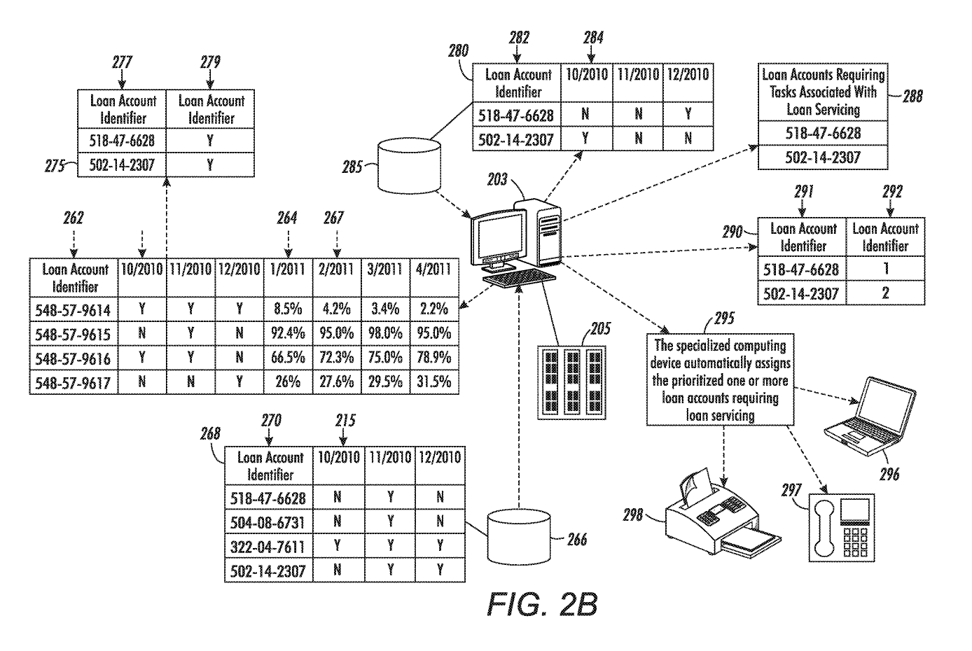

Referring to FIG. 2A, displayed is a block diagram displaying a process of execution of an embodiment of the invention during an off-line mode. A specialized computing device is displayed 203. The specialized computing device receives a first plurality of loan accounts 200 describing the plurality of loan accounts for loan risk analysis. The first plurality of loan accounts is identified according to loan account identifier 261. The first plurality of loan account histories are stored in and transmitted from a first computer database 210 and stored into associated memory 205. Each loan account history of the first plurality of loan account histories 200 contains data points such as the loan account identifier for each loan 205, as well as whether payments were current for each month (displayed specifically is October 2010 (215), November 2010 (220), and December 2010 (225)). A maximum value variable is set 230, here m=4, because there are four loan accounts shown 200. A definition is received from a single user of a predetermined maximum look-ahead timeframe p (240). An iterative variable is set to 0, or i=0 (245). As execution proceeds, a check is then performed as to whether the iterative variable i is less than the maximum value variable m (250). While the iterative variable i is less than the maximum value variable m, a loop is performed as follows: a plurality of variables associated with a loan account history of the first plurality of loan account histories equaling the iterative variable of the plurality of loan account histories is retrieved (253) and stored into memory associated with the specialized computing device (205), then the iterative variable i is incremented by one (255). Execution then returns to 250 where another determination is made whether i<m (250), and execution proceeds accordingly. Eventually, the specialized computing device 203 trains a predictive multi-output risk model 260 using all of the pluralities of variables associated with all of the loan account histories (253) previously stored in memory 205. The predictive multi-output risk model 260 may describe current risk level (263), future risk level (265), and, in an embodiment of the invention, also contain historical data (262). Current risk level 263 for the current month and future risk level 265 for a future month is displayed as a calculated percentage likelihood of default on any given month 263.

Referring to FIG. 2B, displayed is a block diagram displaying a further process of execution of an embodiment of the invention during an online mode. A specialized computing device 203 with associated memory 205 is again displayed. The specialized computing device 203 receives and stores into associated memory 205 a second plurality of loan account histories 268. The second plurality of loan account histories 268 is stored in and transmitted from a second computer database 266. Each loan account history of the second plurality of loan account histories 268 may contain data points such as the loan account identifier for each loan 270, as well as whether payments were current for each month (displayed is October 2010 (272), as well as November 2010 and December 2010 (not numbered)). The specialized computing device 203 then determines at 275 based upon the trained predictive multi-output risk model 260 which one or more loan accounts, with histories stored in the second computer database 266 have a future risk level greater than a current risk level (279). The loan accounts are identified by loan account identifier (277). A third computer database 285 associated with the specialized computing device 203 is accessed by the computing device 203. The third computer database 285 stores data regarding loan servicing histories of the one or more loan accounts contained in the second computer database 266 and determined to have future risk level greater than current risk level by the specialized computing device 203 based upon the trained predictive multi-output risk model 260. These loan accounts are displayed 280. The loan accounts are identified by loan account identifier 282. The loan servicing histories for October 2010 are displayed 284, as well as November 2010 and December 2010 (not numbered). A “Y” indicates a loan servicing attempt or task was made or performed within a given month, whereas an “N” indicates a loan servicing attempt was not made within a given month. The specialized computing device 203 determines which loan accounts of the one or more determined to have future risk level greater than current risk level currently require one or more tasks associated with loan servicing (288), based upon the data regarding loan servicing histories previously accessed. The specialized computing device 203 then prioritizes for assignment one or more loan accounts determined to have future risk level greater than current risk level and requiring one or more tasks associated with loan servicing. Results are displayed 290. Displayed is a loan account identifier 291 associated with each prioritized loan account requiring servicing as well as the priority of assignment 292. Although not displayed here, in an embodiment of the invention, the specialized computing device may determine a complexity of the one or more tasks associated with loan servicing and use this information later. In an embodiment of the invention, the specialized computing device automatically assigns the prioritized one or more loan accounts requiring servicing (295), as according to the priority of assignment 292. In a further embodiment of the invention, the loan servicing is performed via a contact initiated automatically via a computer 296 (such as an e-mail or an instant message), a telephone 297, or a facsimile machine 298.

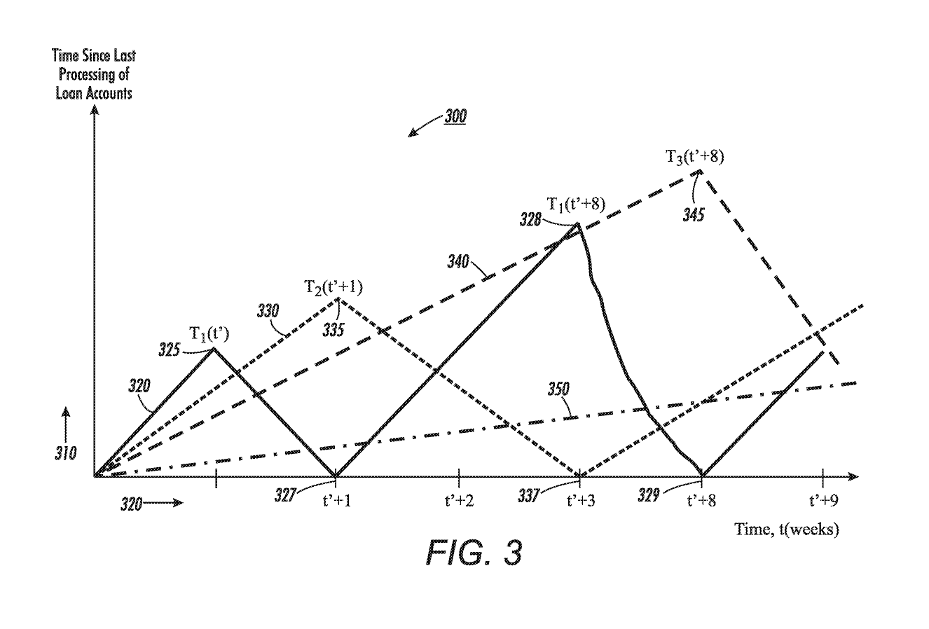

Referring to FIG. 3, displayed is a chart 300 displaying results of a processing of assignment of loan accounts for servicing automatically by the specialized computing device acting as an agent or by a human agent in an embodiment of the invention. FIG. 3 displays a simplified case where there are only four loan accounts (n=4) being serviced, but any number may be processed in an embodiment of the invention. The loan accounts are named, again for simplicity's sake, “loan account 1,” 320, “loan account 2,” 330, “loan account 3,” 340, and “loan account 4,” 350. There is one agent (m=1). X-axis 320 displays “Time, t (weeks).” Y-axis 310 displays “prioritized time since last processing of loan accounts.” As shown in FIG. 3, suppose that at some time t′, a value of prioritized time since last processing of the loan is T₁(t′)>0, and the agent processes loan account 1 320. At time t′ the agent initiates the processing of account 1 320, with the processing indicated at point 325, and the amount of time that it takes to do so is dictated by a parameter τ₁=1 (t′+1−t′). When processing for account 1 320 is completed at time t′+1 (327), the agent chooses to process account 2, beginning at point 335. In an embodiment of the invention, the agent may not have much experience processing this type of loan account, so it takes him/her/it more time to process it. At time t′+3 (337), the agent chooses loan account 1 320 again at point 328; however, this account has some difficulties that cause the agent to take until time t′+8 to process it (329). The process continues in this fashion so that, in this case, the agent alternatively processes accounts {1, 2, 1, 3, . . . }. Notice that since account 4 350 has a low priority, it is not selected for processing during this time frame, but eventually, as its associated risk increases above the risk of the other accounts in question, it will be processed by the agent.

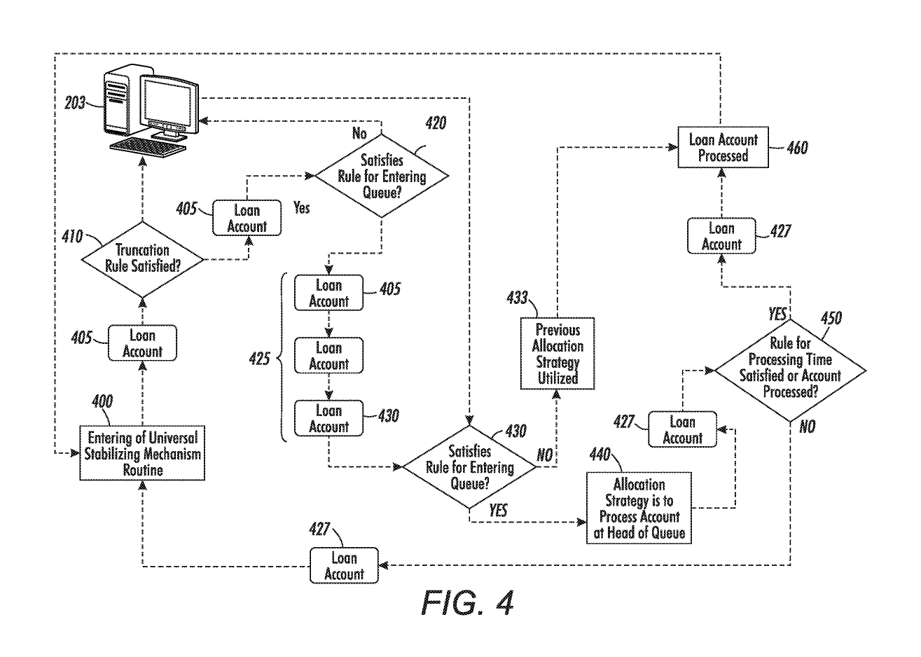

Referring to FIG. 4, displayed is a flowchart displaying a process of execution of an embodiment of the invention, specifically utilizing a Universal Stabilizing Mechanism. The Universal Stabilizing Mechanism may be utilized in circumstances where processing takes more time than what is expected, such as when processing a complex loan account by an inexperienced agent, or when processing by an untrained computerized agent which results in exponential decay of prioritized time. One option for entering the Universal Stabilizing Mechanism is to establish a threshold at which assignment options are made (as opposed to when T_{k*}_{ⱼ}(t_{k*}_{ⱼ})=0; see e.g., FIG. 3.) There also may be circumstances where agents have significant knowledge about accounts he/she/it regularly processes, and such knowledge is to be incorporated in the design of loan account selection strategy (i.e., a heuristics strategy selection). The Universal Stabilizing Mechanism may be used in these circumstances. The Universal Stabilizing Mechanism may be considered as follows: Execution utilizing the Universal Stabilizing Mechanism is begun 400. A loan account 405 is considered. At step 410, a truncation rule is used to analyse the loan account 405. The truncation rule may be stated as follows: any agent j ∈ Q may process any account k ∈ P for no longer than ζ time units. If the agent has processed an account for time ζ, then the controller (or specialized computing device 203) is forced to make a new decision. In effect, at step 410, the truncation rule simply considers whether the loan account 405 has been processed longer than ζ time units, where ζ is denoted as truncation time. If the truncation rule is not satisfied, the specialized computing device 203 is forced to make a new decision. If the truncation rule 410 is satisfied, another check is performed at step 420, where it is determined whether loan account 405 satisfies the rule for entering a First-Come-First-Served queue [symbol] of loan accounts awaiting processing 425. The loan account k enters the tail of the queue 425 at time t if no agent has processed account k and Tₖ_{ⱼ} (tₖ)>φₖ_{ⱼ}, where φₖ_{ⱼ} is a threshold for when an account enters the queue. The loan account 405 waits at the end of the queue [symbol] 425, and moves forward in queue [symbol] 425 as the loan account or accounts ahead of it are processed, as one of skill in the art understands. At step 430, a determination is made whether there is more than one account in the queue [symbol] 425. If no, execution proceeds to step 433 where an allocation strategy such as discussed above in connection with equation 1 or 2 of FIG. 1 is utilized and execution then proceeds to step 460, as further discussed below. If yes, execution proceeds to step 440 where the allocation strategy utilized is for an agent to process the account at the head of the queue 427. The loan account at the head of the queue 427 leaves the queue 425 when an agent begins processing it. The loan account 427 is processed until it is fully processed by an agent (i.e., Tₖ (tₖ)=0) or until the elapsed time ζ elapses (whichever occurs first). This is displayed in FIG. 4 as decision 450. If processing is complete, execution proceeds to 460 for loan account 427. If processing does not complete before elapsed time ζ elapses, the loan account 427 is skipped and execution returns to 400. As one of skill in the art would understand, execution as displayed within FIG. 4 is a continual process, looping until no more loans remain to be processed or execution terminates via an external force.

The complexity level of a particular account may be derived based on archived data of prior engagements or real-time/up-to-date data of ongoing engagements. The term engagement refers to the process of carrying out tasks associated with loan servicing. Data descriptive of the complexity of a current or prior engagement includes, but is not limited to, the number of times that an agent did not finish processing an account, profiles of agents and accounts, actual processing times, and descriptive statistics of probabilistic processing times. In one example, let nⱼₖ denote the number of times that agent j did not finish processing account k in ζ time units (i.e., the truncation time of the Universal Stabilizing Mechanism described above) and nₖ=Σⱼnⱼₖ denote the number of times that account k was not completely processed by any agent in ζ time units. The complexity level of account k may be defined based on the value of nₖ. The greater the value of nₖ, the greater the complexity level. Furthermore, the complexity level of account k for agent j can be defined based on the value of nⱼₖ. Note that this information can be used in addition to Equation 1 or 2 to allocate accounts to agents based on the complexity level. The addition can be specifically applied to break ties in those equations by assigning the account nₖ*to agent j with nₖ*=minₖ(nₖⱼ), which particularly assigns the account that has been more successfully processed by agent j among the ones included in the tie. The other option is to define queue [symbol] of the Universal Stabilizing Mechanism with the values nⱼₖ and the agent j processes account k associated to nⱼₖ when the queue is not empty. Note also that a combination of both scenarios can be implemented as well.

In a second example, profiles of at least two agents and at least two accounts can be generated from available data. An account profile may be created based on variables included in the loan account history and is informative of the nature of the account. An agent profile can be created based on his/her past experience, namely his/her historic performance as related to processing accounts with different profiles. For example, an array of the processing times of each account contained in each agent profile is logged in the agent profile. The expected complexity level of account k for agent j may be determined based on a metric defined from the array of processing times. In another example, the processing time for the account in the agent profile that is most similar to account k is used as an estimate of the expected complexity. In another example, the accounts in the agent profile are clustered into groups, and a combination of processing times in the cluster found to be most similar to account k is used as an estimate of the expected complexity. In yet another example, where account k is already present in the agent profile (because the agent processed that account in the past), the processing time for that account in the agent profile is used as an estimate of the expected complexity.

In another example, the estimated complexity or processing time for account k and for a group of agents is compared to truncation time ζ. The agent with the expected processing time smaller than time ζ may be assigned to the account. In alternative embodiments, other selection rules can be enforced. For example, the agent with expected processing time closest to ζ can be assigned to the account. In yet another example, instead of a deterministic expected processing time, the expected processing time may be modelled in the form of a probabilistic distribution. In the example where the accounts in the agent profile are grouped into clusters, the distribution is estimated from the multiple observations comprising the multiple accounts belonging to the cluster that was found to be most similar to account k.

The expected processing time can be determined by computing a desired percentile of the processing times or by computing the probability that agent j will completely process account k at ζ time units given the estimated distribution. In this example, the greater the percentile of the processing times, the greater the complexity level; the smaller the probability of completely processing an account, the greater the complexity level. These complexity metrics are used as previously described to break ties in Equation 1 or 2 to allocate accounts to agents based on the complexity level; these complexity metrics may also be included in the queue [symbol] to decide when agent j processes account k when the queue is not empty; a combination of both scenarios may be implemented as well.

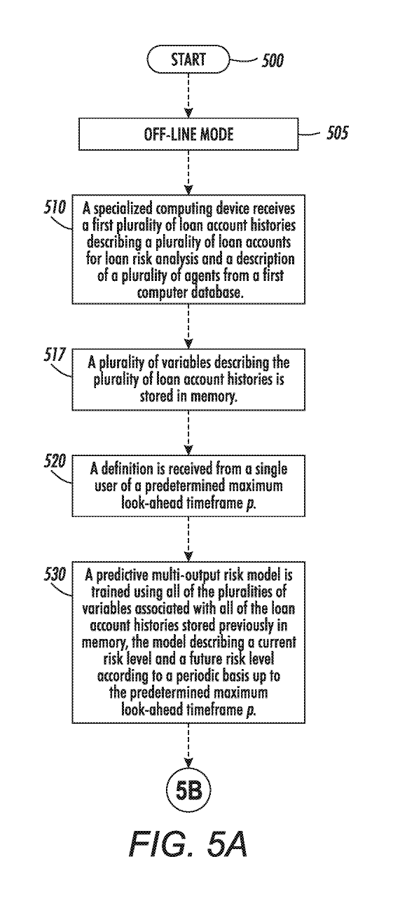

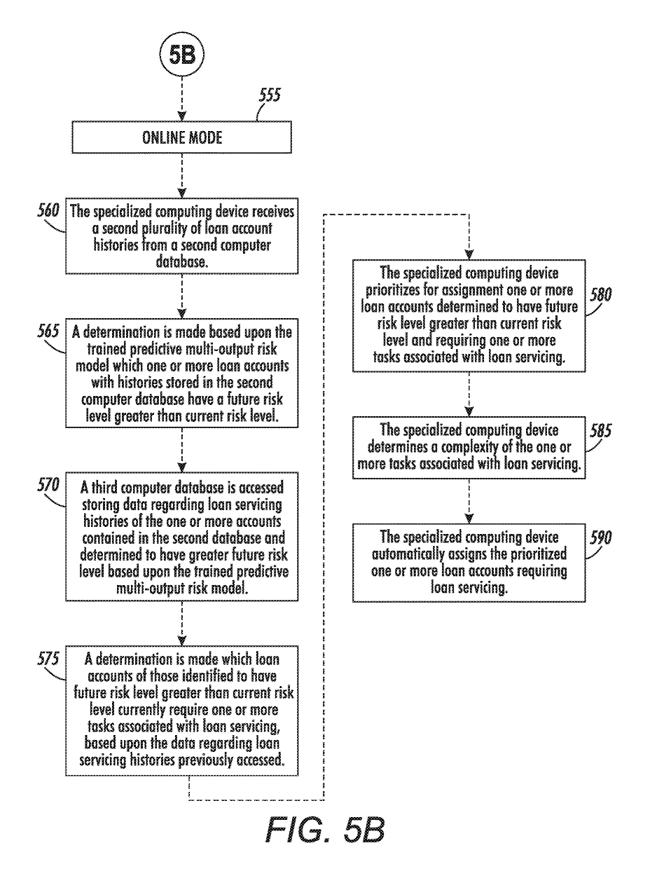

Referring to FIG. 5A, displayed is a flowchart displaying a process of execution of a second embodiment of the invention. Execution begins at step 500. An “Off-Line Mode” begins, in an embodiment of the invention, at step 505 and onwards. At step 510, a specialized computing device receives a first plurality of loan account histories describing a plurality of accounts for loan risk analysis and a description of the plurality of agents from a first computer database. As to be understood in the context of the presently disclosed invention, any and all databases discussed herein may be one database or multiple databases linked together, all serving requests for data as may be transacted by the specialized computing device or any other computing device discussed herein.

At step 517 a plurality of variables describing the plurality of loan account histories is stored in memory. At step 520, a definition is received from a single user of a predetermined maximum look-ahead timeframe p. Execution proceeds to step 530 where a predictive multi-output risk model is trained using all of the pluralities of variables associated with all of the loan account histories stored previously in memory, the model describing a current risk level and a future risk level according to a periodic basis up to the predetermined maximum look-ahead timeframe p. The periodic basis used in training the predictive multi-output risk model may equal, in various embodiments, to one day, one week, one month, six months, and one year. Execution then proceeds to FIG. 5B, as is further discussed below. Execution of the off-line mode is complete with the training of the risk model and storing of its parameters.

Referring to FIG. 5B, displayed is a flowchart also displaying a further process of execution of an embodiment of the invention. As discussed in step 555 and onwards, in an embodiment of the invention an “Online Mode” 555 et seq. follows the “Off-Line Mode” 505 et seq. At step 560, the specialized computing device receives and stores into associated memory a second plurality of loan account histories from a second computer database. The second plurality of loan account histories stored in the second computer database may comprise one or more of the following: an updating of the first plurality of loan account histories contained in the first computer database, a plurality of loan account histories not contained in the first computer database, and a combination of the updating of the first plurality of loan account histories and the plurality of loan account histories not contained in the first computer database. At step 565 a determination is made based upon the trained predictive multi-output risk model which one or more loan accounts with histories stored in the second computer database have a future risk level greater than a current risk level. At step 570, a third computer database is accessed storing data regarding loan servicing histories of the one or more loan accounts contained in the second database and determined to have future risk level greater than current risk level based upon the trained predictive multi-output risk model. The data regarding loan servicing histories of the one or more loan accounts stored in the third database includes at least a date of loan origination, a date of first loan servicing, zero or more dates of subsequent loan servicing, and zero or more dates of loan payments made. At step 575, a determination is made which loan accounts of those identified to have future risk level greater than current risk level currently require one or more tasks associated with loan servicing based upon previously accessed loan servicing data. Tasks associated with loan servicing may be one or more of the following, including requesting a payment on the determined one or more loan accounts, advising of delinquency regarding the determined one or more loan accounts, advising of a pay-off amount for the determined one or more loan accounts, and responding to a specific client request regarding the determined one or more loan accounts. At step 580 the specialized computing device prioritizes for assignment one or more loan accounts determined to have future risk level greater than current risk level and requiring one or more tasks associated with loan servicing. In an embodiment of the invention, prioritizing for assignment the one or more loan accounts comprises automatically determining one or more loan accounts whose prioritized time since previous loan servicing satisfies a prioritization criterion, based upon the data regarding loan servicing histories in the third computer database.

During enforcement of the online prioritization criterion, the automatic determination of the one or more prioritized loan accounts comprises selecting accounts with prioritized time greater or equal to the average prioritized time of all or a group of accounts since previous loan servicing at time tₖj, such that:

$${T}_{{k}_{j}^{*}} ( {t}_{{k}_{j}^{*}} ) \geq \frac{1}{n - m} {Σ}_{{k}_{j} ∈ U ( {t}_{{k}_{j}} )} {T}_{{k}_{j}} ( {t}_{{k}_{j}} ) . \qquad Equation 1$$

Alternately, during enforcement of the online prioritization criterion, the automatic determination of the one or more prioritized loan accounts comprises selecting accounts with longest prioritized time since previous loan servicing occurs at time tₖj, such that:

T_{k*}_{ⱼ}(t_{k*}_{ⱼ})=maxₖ_{ⱼ}_{∈U(t}_{ₖⱼ}₎{Tₖ_{ⱼ}(tₖ_{ⱼ})}. Equation 2

During the online mode when prioritizing for assignment the one or more loan accounts determined to have future risk level greater than current risk level control strategies may be used to generate an allocation of accounts and a Universal Stabilizing Mechanism guarantees all accounts are serviced.

At step 585, the specialized computing device may determine a complexity of the one or more tasks associated with loan servicing. In a further embodiment of the invention, the complexity level of the one or more tasks is related to a history of prior engagements with a customer associated with each loan account the task is required for. At step 590 the specialized computing device automatically assigns the prioritized one or more loan accounts requiring loan servicing. The computing device may use a heuristic allocation strategy to assign one or more loan accounts to the one or more determined agents. The allocation strategy utilized may be:

$${T}_{{k}_{j}^{*}} ( {t}_{{k}_{j}^{*}} ) \geq \frac{1}{n - m} {\sum }_{{k}_{j} ∈ U ( {t}_{{k}_{j}} )} {T}_{{k}_{j}} ( {t}_{{k}_{j}} )$$

The preceding description has been presented only to illustrate and describe the invention. It is not intended to be exhaustive or to limit the invention to any precise form disclosed. Many modifications and variations are possible in light of the above teachings.

As will be appreciated by one of skill in the art, the presently disclosed invention is intended to comply with all relevant local, city, state, federal, and international laws and rules.

The preferred embodiments were chosen and described in order to best explain the principles of the invention and its practical application. The preceding description is intended to enable others skilled in the art to best utilize the invention in its various embodiments and with various modifications as are suited to the particular use contemplated. It is intended that the scope of the invention be defined by the following claims.

What is claimed is:

1. A method of using a specialized computing device for determining a future risk associated with a plurality of accounts, said method comprising:
In an off-line mode associated with the specialized computing device:
Receiving by the specialized computing device and storing into associated memory a first plurality of account histories describing the plurality of accounts for risk analysis, the first plurality of account histories stored in and transmitted from a first computer database;
Setting a maximum value variable m equal to a number of the received first plurality of account histories stored in associated memory;
Receiving a definition from a single user of a predetermined maximum look-ahead timeframe p;
Setting an iterative variable i equal to zero;
While the iterative variable i is less than the maximum value variable m then iteratively performing the following steps a. though b.:
a. Retrieving and storing into memory associated with the specialized computing device a plurality of variables associated with an account history of the first plurality of account histories equaling the iterative variable i of the plurality of account histories;
b. Incrementing the iterative variable i by one;
Training with the specialized computing device a predictive multi-output risk model using all of the pluralities of variables associated with all of the account histories stored previously in memory, the predictive multi-output risk model describing a current risk level and a future risk level according to a periodic basis up to the predetermined maximum look-ahead timeframe p; and
In an online mode associated with the specialized computing device:
Receiving by the specialized computing device and storing into associated memory a second plurality of account histories, the second plurality of account histories stored in and transmitted from a second computer database;
Determining, using the specialized computing device, based upon the trained predictive multi-output risk model, which one or more accounts with histories stored in the second computer database have a future risk level greater than a current risk level;
Accessing a third computer database associated with the specialized computing device, the third computer database storing data regarding servicing histories of the one or more accounts contained in the second database and determined to have future risk level greater than current risk level by the specialized computing device based upon the trained predictive multi-output risk model;
Determining by the specialized computing device which accounts of the one or more determined to have future risk level greater than current risk level currently require one or more tasks associated with servicing, based upon the data regarding servicing histories previously accessed;
Prioritizing by the specialized computing device for assignment one or more accounts determined to have future risk level greater than current risk level and requiring one or more tasks associated with servicing; and
Assigning automatically via the specialized computing device the prioritized one or more accounts requiring servicing.

2. The method of claim 1, wherein the second plurality of account histories stored in the second computer database comprises selectively one of the following: an updating of the first plurality of account histories contained in the first computer database, a plurality of account histories not contained in the first computer database, and a combination of the updating of the first plurality of account histories and the plurality of account histories not contained in the first computer database.

3. The method of claim 1, wherein the periodic basis used in training the predictive multi-output risk model is equal to selectively one of the following: one day, one week, one month, six months, and one year.

4. The method of claim 1, wherein the data regarding servicing histories of the one or more accounts stored in the third database includes at least a date of origination, a date of first servicing, zero or more dates of subsequent servicing, and zero or more dates of payments made.

5. The method of claim 1, wherein prioritizing for assignment the one or more accounts determined to have future risk level greater than current risk level comprises automatically determining one or more accounts with a longest time since previous servicing, based upon the data regarding servicing histories in the third computer database.

6. The method of claim 5, wherein during enforcement of the online prioritization criterion, the automatic determination of the one or more prioritized accounts comprises selecting accounts with prioritized time greater or equal to the average prioritized time of all or a group of accounts since previous servicing at time tₖj, such that:
$${T}_{{k}_{j}^{*}} ( {t}_{{k}_{j}^{*}} ) \geq \frac{1}{n - m} {Σ}_{{k}_{j} ∈ U ( {t}_{{k}_{j}} )} {T}_{{k}_{j}} ( {t}_{{k}_{j}} ) .$$

7. The method of claim 5, wherein during enforcement of the online prioritization criterion, the automatic determination of the one or more prioritized accounts comprises selecting accounts with a longest prioritized time since previous servicing occurs at time tₖj, such that:
T_{k*}_{ⱼ}(t_{k*}_{ⱼ})=maxₖ_{ⱼ}_{∈U(t}_{ₖⱼ}₎{Tₖ_{ⱼ}(tₖ_{ⱼ})}

8. The method of claim 1, wherein the one or more tasks associated with servicing comprise selectively one of the following: requesting a payment on the determined one or more accounts, advising of delinquency regarding the determined one or more accounts, advising of a pay-off amount for the determined one or more accounts, and responding to a specific client request regarding the determined one or more accounts.

9. The method of claim 1, further comprising before automatically assigning the one or more prioritized accounts, determining a complexity of the one or more tasks associated with servicing.

10. The method of claim 9, wherein the complexity level of the one or more tasks is related to a history of prior engagements with a customer associated with each account the task is required for.

11. The method of claim 10, wherein during the online mode when prioritizing by the specialized computing device for assignment the one or more accounts determined to have future risk level greater than current risk level control strategies are used to generate an allocation of accounts and a Universal Stabilizing Mechanism guarantees all accounts are serviced.

12. The method of claim 11, wherein the specialized computing device utilizes an allocation strategy
$${T}_{{k}_{j}^{*}} ( {t}_{{k}_{j}^{*}} ) \geq \frac{1}{n - m} {Σ}_{{k}_{j} ∈ U ( {t}_{{k}_{j}} )} {T}_{{k}_{j}} ( {t}_{{k}_{j}} )$$
to assign one or more accounts to one or more agents.

13. The method of claim 11, wherein the specialized computing device utilizes a heuristic allocation strategy to assign one or more accounts to the one or more agents.

14. A method for allocation of a plurality of loan accounts to a plurality of agents by a specialized computing device managing a contact center, the specialized computing device having an off-line mode and an online mode, said method comprising:
In the off-line mode associated with the specialized computing device:
Receiving by the specialized computing device and storing into associated memory a first plurality of loan account histories describing the plurality of loan accounts for loan risk analysis and a description of the plurality of agents, the first plurality of loan account histories stored in and transmitted from a first computer database;
Storing in memory associated with the specialized computing device a plurality of variables describing the plurality of loan account histories;
Receiving a definition from a single user of a predetermined maximum look-ahead timeframe p;
Training with the specialized computing device a predictive multi-output risk model using all of the pluralities of variables associated with all of the loan account histories stored previously in memory, the predictive multi-output risk model describing a current risk level and a future risk level according to a periodic basis up to the predetermined maximum look-ahead timeframe p; and
In the online mode associated with the specialized computing device:
Receiving by the specialized computing device and storing into associated memory a second plurality of loan account histories, the second plurality of loan account histories stored in and transmitted from a second computer database;
Determining, using the specialized computing device, based upon the trained predictive multi-output risk model, which one or more loan accounts with histories stored in the second computer database have a future risk level greater than a current risk level;
Accessing a third computer database associated with the specialized computing device, the third computer database storing data regarding loan servicing histories of the one or more loan accounts contained in the second database and determined to have future risk level greater than current risk level by the specialized computing device based upon the trained predictive multi-output risk model;
Determining by the specialized computing device which loan accounts of the one or more determined to have future risk level greater than current risk level currently require one or more tasks associated with loan servicing, based upon the data regarding loan servicing histories previously accessed;
Prioritizing by the specialized computing device for assignment one or more loan accounts determined to have future risk level greater than current risk level and requiring one or more tasks associated with loan servicing; and
Assigning automatically via the specialized computing device the prioritized one or more loan accounts requiring loan servicing.

15. The method of claim 14, wherein the second plurality of loan account histories stored in the second computer database comprises selectively one of the following: an updating of the first plurality of loan account histories contained in the first computer database, a plurality of loan account histories not contained in the first computer database, and a combination of the updating of the first plurality of loan account histories and the plurality of loan account histories not contained in the first computer database.

16. The method of claim 14, wherein the periodic basis used in training the predictive multi-output risk model is equal to selectively one of the following: one day, one week, one month, six months, and one year.

17. The method of claim 14, wherein the data regarding loan servicing histories of the one or more loan accounts stored in the third database includes at least a date of loan origination, a date of first loan servicing, zero or more dates of subsequent loan servicing, and zero or more dates of loan payments made.

18. The method of claim 14, wherein prioritizing for assignment the one or more loan accounts determined to have future risk level greater than current risk level comprises automatically determining one or more loan accounts whose prioritized time since previous loan servicing satisfies a prioritization criterion, the prioritization criterion based upon the data regarding loan servicing histories in the third computer database.

19. The method of claim 18, wherein enforcement of the prioritization criterion comprises selecting accounts with prioritized time greater or equal to the average prioritized time of all or a group of accounts since previous loan servicing at time tₖj, such that accounts indexed by k*ⱼ satisfy:
$${T}_{{k}_{j}^{*}} ( {t}_{{k}_{j}^{*}} ) \geq \frac{1}{n - m} {Σ}_{{k}_{j} ∈ U ( {t}_{{k}_{j}} )} {T}_{{k}_{j}} ( {t}_{{k}_{j}} ) .$$

20. The method of claim 18, wherein enforcement of the prioritization criterion comprises selecting accounts with a longest prioritized time since previous loan servicing at time tₖj, such that accounts indexed by k*ⱼ satisfy:
T_{k*}_{ⱼ}(t_{k*}_{ⱼ})=maxₖ_{ⱼ}_{∈U(t}_{ₖⱼ}₎{Tₖ_{ⱼ}(tₖ_{ⱼ})}

21. The method of claim 18, wherein when prioritizing by the specialized computing device for assignment the one or more loan accounts determined to have future risk level greater than current risk level, control strategies are used to generate an allocation of accounts and a Universal Stabilizing Mechanism is used to guarantee all accounts are serviced.

22. The method of claim 21, wherein the control strategies include an allocation strategy where accounts indexed by k*ⱼ such that
$${T}_{{k}_{j}^{*}} ( {t}_{{k}_{j}^{*}} ) \geq \frac{1}{n - m} {Σ}_{{k}_{j} ∈ U ( {t}_{{k}_{j}} )} {T}_{{k}_{j}} ( {t}_{{k}_{j}} )$$
are assigned to one or more available agents.

23. The method of claim 21, wherein the control strategy comprises a heuristic allocation strategy to assign one or more loan accounts to the one or more available agents.

24. The method of claim 1, wherein the one or more tasks associated with loan servicing comprise selectively one of the following: requesting a payment on the determined one or more loan accounts, advising of delinquency regarding the determined one or more loan accounts, advising of a pay-off amount for the determined one or more loan accounts, and responding to a specific client request regarding the determined one or more loan accounts.

25. The method of claim 14, further comprising before automatically assigning the one or more prioritized loan accounts, determining a complexity of the one or more tasks associated with loan servicing.

26. The method of claim 25, wherein the complexity level of the one or more tasks is derived from data of prior and current engagements with a customer associated with each loan account the task is required for.

27. The method of claim 10, wherein the complexity level is determined from one or more of the following: the number of times that an agent did not finish processing an account, profiles of agents and accounts, processing times, and descriptive statistics of probabilistic processing times.

28. The method of claim 6, wherein the automatic determination of the one or more prioritized loan accounts further comprises selecting a subset of the set of initially selected accounts based on the estimated complexity level of tasks associated with accounts in the set.

29. The method of claim 7, wherein the automatic determination of the one or more prioritized loan accounts further comprises selecting a subset of the set of initially selected accounts based on the estimated complexity level of tasks associated with accounts in the set.

30. The method of claim 8, wherein the complexity level of tasks associated with an account are input into the Universal Stabilizing Mechanism.
